(19) United States
(12) Patent Application Publication
(10) Pub. No.: US 2006/0008731 A1
(43) Pub. Date: Jan. 12, 2006

(54) Novel photoresist monomers and polymers

(76) Inventors: Michael Van Der Puy, Amherst, NY (US); Jingji Ma, West Seneca, NY (US); Dennis M. Lavery, Springville, NY (US); Lawrence A. Ford, Buffalo, NY (US); Haridasan K. Nair, Williamsville, NY (US); David Nalewajek, West Seneca, NY (US); Andrew J. Poss, Kenmore, NY (US); Leonard M. Stachura, Hamburg, NY (US)

Correspondence Address: COLLEEN D. SZUCH;Honeywell International Inc., Patent Department, 101 Columbia Road, Morristown, NJ, 07962, US

(21) Appl. No.: 10/888,746

(22) Filed: Jul. 9, 2004

(51) Int. Cl. G03C 1/492

(52) U.S. Cl. 430/270.1

(57) ABSTRACT

Monomers and polymers useful for forming photoresists. More particularly, photoresists, as well as monomers and polymers for photoresists useful in micro-lithography, specifically monomers bearing acid-labile groups of reduced optical density. The resulting photoresists exhibit improved transparency to 157 nm light. The photoresist compositions are composed of a mixture of at least one water insoluble, acid decomposable polymer which is prepared from at least one monomer having a monomeric unit structure which comprises: 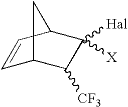 where Hal=F, Cl or Br and X=H or F; and which is substantially transparent to ultraviolet radiation at a wavelength of about 157 nm, and at least one photoacid generator capable of generating an acid upon exposure to sufficient activating energy at a wavelength of about 157 nm.

### BACKGROUND OF THE INVENTION

The invention relates to monomers and polymers useful for forming photoresists. More particularly, the invention pertains to photoresists, as well as monomers and polymers for photoresists useful in 157 nm micro-lithography applications.

Photoresists are organic polymeric materials that are used in a wide variety of applications, including lithographic imaging materials for semiconductor applications, particularly microlithography processes for making miniature electronic components. Generally in these processes a thin film coating of a photoresist composition is applied to a substrate, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation. Visible light, ultraviolet (UV) light, electron beam and X-ray radiant energy are radiation types commonly used today in microlithographic processes.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal the non-exposed areas of the photoresist coating and the creation of a negative image in the coating, thereby uncovering a desired portion of the underlying substrate surface on which the photoresist composition was deposited.

Alternately, when positive-working photoresist compositions are exposed image-wise to radiation, those areas of the photoresist composition exposed to the radiation become more soluble to the developer solution while those areas not exposed remain relatively insoluble to the developer solution. More specifically, one type of a positive-working system, the radiation causes a photo-acid component of the photoresist to produce an acid. The presence of this acid causes the hydrolysis of an acid labile group present in another component of the photoresist, producing hydrolysis products that are soluble in an aqueous base. After this image-wise exposure, the coated substrate is treated with a aqueous base developer solution to dissolve and remove the radiation exposed areas of the photoresist. Thus, treatment of an exposed positive-working photoresist with the developer causes removal of the exposed areas of the coating and the creation of a positive image in the photoresist coating. Therefore, a desired portion of the underlying surface is uncovered, and the uncovered substrate is thereafter subjected to an etching process. Frequently this involves a plasma etching against which the photoresist coating must be sufficiently stable. The photoresist coating protects the covered areas of the substrate from the etchant and thus the etchant is only able to etch the uncovered areas of the substrate. Thus, a pattern can be created on the substrate which corresponds to the pattern of the mask or template that was used to create selective exposure patterns on the coated substrate prior to development.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, photoresist resolution on the order of less than one micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

As semiconductor devices continue to become smaller and more miniaturized, the ability to reproduce very small dimensions is extremely important. As the integration degree of semiconductor devices becomes higher, finer photoresist film patterns are required. This has lead to the use of new photoresists that are sensitive to lower wavelengths of radiation and has also led to the use of sophisticated multilevel systems to overcome difficulties associated with such miniaturization.

Photoresist polymers are typically terpolymers, each monomer having a specific function. The base polymer is chiefly responsible for low optical density. For example, tetrafluoroethylene is a good base polymer providing low optical density at 157 nm, but has drawbacks in other areas such as adhesion and etch resistance. This performance function must be fulfilled by another component in the system. Another monomer functions as a solubility switch. It is transformed when acid is produced upon irradiation. A third monomer usually provides etch resistance or is used to modify the polymer to provide optimum properties for a variety of system requirements such Tg, organic solubility, adhesion, and etch resistance. Modification of polymer properties may be especially difficult, however, if the monomers used have widely different polymerization reactivities. Thus there is a continuing need to provide simple systems that satisfy as many performance criteria as possible. Ideally, each monomer has desirable features, such as low optical density but does not have associated undesirable features such as low etch resistance.

The optimally obtainable microlithographic resolution is essentially determined by the radiation wavelengths used for the selective irradiation. However, the resolution capacity that can be obtained with conventional deep UV microlithography has its limits. In order to be able to sufficiently resolve optically small structural elements, wavelengths shorter than typical UV radiation must be utilized. The use of deep UV radiation has been employed for many applications, particularly radiation with wavelengths of 248 or 193 nm. However, many photoresist materials that are used today lack transparency at 157 nm, and are therefore not suitable for 157 nm lithography. See, for example, U.S. Pat. No. 5,821,036 which describes a method of making positive photoresists and polymer compositions for use therein. The polymer compositions disclosed therein are non-transparent and unusable in 157 nm lithographic applications. U.S. Pat. No. 6,124,074 discloses acid catalyzed positive photoresist compositions that are transparent to 193 nm radiation but are not transparent to 157 nm radiation. U.S. Pat. No. 6,365,322 discloses photoresist compositions for deep UV irradiation that are also non-transparent to 157 nm radiation.

The reason why photoresists typically lack transparency at 157 nm is because the high absorbance of many organic functional groups at 157 nm makes it difficult to develop an organic polymer that is both base soluble and has low absorbance at 157 nm. Traditional photoresist polymers contain either phenols or carboxylic acids to solubilize the base polymer. Both organic groups, phenols and carboxylic acids, impart an excess of absorbance to the polymeric resist material to allow the polymer to be an effective component of a photoresist for 157 nm lithography. More specifically, known materials based on phenolic resins as a binding agent, particularly novolak resins or polyhydroxystyrene derivatives have too high an absorption at wavelengths below 200 nm and one cannot image through films of the necessary thickness. This high absorption, for example at 193 nm radiation, results in side walls of the developed resist structures which do not form the desired vertical profiles. Rather, they have an oblique angle with the substrate that causes poor optical resolution characteristics at these short wavelengths.

Attempts have been made to produce fluorinated polymers that are substantially transparent to light at the 157 nm wavelength. For example, PCT WO 00/67072 describes fluorinated polymers, photoresists and associated processes for microlithography in which their polymers and photoresists are comprised of a fluoroalcohol functional group which simultaneously imparts high ultraviolet transparency and developability in basic media to such materials. U.S. Pat. No. 6,468,712 teaches resist materials including a photo-acid generator and a fluorinated polymer having a protecting group that is labile in the presence of an acid. U.S. Pat. No. 6,486,282 teaches cyano containing polymers for photoresist compositions having at least one non-aromatic cyclic unit. Each of these materials are described as having UV transparency to radiation at the 157 nm wavelength. However, while these materials may exhibit transparency to 157 nm radiation, they do not exhibit other desirable properties such as good resistance to plasma etchants, adhesion to a wide range of substances and surfaces and exceptional mechanical properties in 157 nm lithography applications.

The present invention overcomes these problems in the related art. The present invention describes the preparation of novel polymers, as well as novel monomers for making such polymers, and methods of using such polymers, particularly in 157 nm photoresists. More specifically, the invention describes monomers of the type 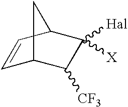
where Hal=F, Cl or Br and X=H or F and polymers and photoresists derived therefrom. The photoresist materials of the invention exhibit good etch resistance, adhesion to a wide range of substances and surfaces and excellent mechanical properties in 157 nm lithography applications.

### DETAILED DESCRIPTION OF THE INVENTION

The invention provides a compound having the structure: 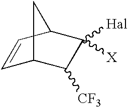
wherein Hal=F, Cl or Br and X=H or F.

The invention also provides a photoresist composition comprising:
(a) at least one polymer which comprises a copolymer which is derived from at least one member which member comprises a compound having the structure: 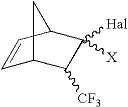
   where Hal=F, Cl or Br and X=H or F;
(b) at least one photoacid generator in an amount sufficient to generate sufficient acid to remove said acid labile group upon exposure to actinic radiation; and
(c) a solvent capable of dissolving the polymer and the photoacid generator; wherein said polymer is present in the photoresist composition in an amount sufficient to form a uniform film of the composition components when it is coated on a substrate and dried.

The invention further provides a process for producing an etch resistant image which comprises:
(a) coating and drying a photoresist composition onto a substrate, which photoresist composition comprises:
   (i) at least one polymer which comprises a copolymer which is derived from at least one member which member comprises a compound having the structure: 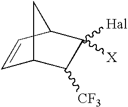
   where Hal=F, Cl or Br and X=H or F; and
   (ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the exposed non-image areas and leaving the unexposed image areas of the photoresist composition.

The invention still further provides a microelectronic device image produced by a process which comprises:
(a) coating and drying a photoresist composition onto a substrate, which photoresist composition comprises:
   (i) at least one polymer which comprises a copolymer which is derived from at least one member which member comprises a compound having the structure: 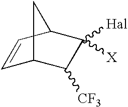
   where Hal=F, Cl or Br and X=H or F; and
   (ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the exposed non-image areas and leaving the unexposed image areas of the photoresist composition.

The first step of the process according to the invention is coating and drying a photoresist composition of the invention onto a substrate. The photoresist compositions of the invention are composed of a mixture of at least one water insoluble, acid decomposable polymer which is derived from at least one monomer compound which has a structure which comprises: 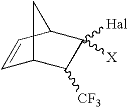
where Hal=F, Cl or Br and X H or F; and which is substantially transparent to ultraviolet radiation at a wavelength of about 157 nm, at least one photoacid generator capable of generating an acid upon exposure to sufficient activating energy at a wavelength of about 157 nm, and optionally other ingredients.

In one preferred compound of the invention, compound I, Hal=F and X=H. In another preferred compound of the invention, compound II, Hal=F and X=F. Both are good monomers for 157 nm photoresist polymers that have a combination of low optical density and good etch resistance. Both monomer types are novel compositions. The monomers can be made, for example, by reacting cyclopentadiene with an olefin of the type CF₃CH=CX(Hal) at temperatures ranging from about 130° C. to about 200° C. and more typically from about 150° C. to about 170° C.

Homopolymers of the invention are preferably derived from about 20 to about 200 repeating units of such compounds, more preferably from about 32 to about 40 of such repeating units. Copolymers of the invention are preferably derived from at least one monomer having the above structure and at least one other co-monomer preferably having an acid labile group. Preferred co-monomers include fluorinated acrylates, fluorinated norbornenes and fluorinated norbornenols, as well as co-monomers selected from the group of CF₂=CF₂, CF₂=CFH, CF₂=CH₂, CF₃CF=CH₂, CF₃CH=CHF and CH₂=CHCH₂C(CF₃)OHCF₂CF=CF₂.

Particularly preferred polymers of the invention are derived by the polymerization of at least one compound having the structure: 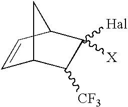
where Hal=F, Cl or Br and X=H or F and at least one co-monomer having an acid labile group. In a typical photoresist, the photoresist polymer has an acid labile group that functions to change the solubility of the photoresist polymer when a photo-acid generator component of the photoresist produces an acid upon irradiation. In the presence of the acid, the acid labile group is cleaved, producing hydrolysis products that are soluble in aqueous base.

Typically, photoresist polymers are composed of multiple comonomers, each of which brings a desired feature to the polymer. For example, monomers with acid labile groups bring a solubility switch, norbornenes bring etch resistance and the comonomers listed above (i.e., CF2=CF2. etc.) bring transparency. The novel monomers of the invention preferably comprise from about 5% to about 50% by weight of the overall polymer for the photoresist compositions of the invention, more preferably from about 15% to about 40% by weight of the polymer, with the balance comprising other suitable co-monomers. The amount will depend on the solubility characteristics of the other monomers. For example, if one of the monomers is a fluorinated norbornene that has good solubility in a developer solution, then the amount of the monomer having the acid labile group will be lower. However, if one of the monomers, for example, has no solubilizing functional groups, such as a fluorinated ethylene, a higher percentage of the polymer will comprise monomers having the acid labile group.

Preferred co-monomers for use herein are monomeric esters wherein the alcohol portion of the ester has the formula —OC(CH₃)₂CF₃. Such co-monomers are particularly useful in forming polymers for photoresists having reduced optical density while maintaining the essential function of an acid labile group. Accordingly, the photoresist materials of the invention exhibit good etch resistance, adhesion to a wide range of substances and surfaces and excellent mechanical properties in 157 nm lithography applications.

Particularly preferred are co-monomers having the structure:
CR¹R²=CR³—Y—C(O)OC(CH₃)₂CF₃
where R¹ is H, F or part of a norbornene structure linked to R³; R² is H or F; R³ is H, F, CF₃, CH₃, Cl, CN or part of a norbornene structure linked to R²; Y is a nil or a spacer group which comprises an alkylene or fluorinated alkylene moiety of 1-5 carbons. It should be noted that while R³ may comprise H, F, CF₃, CH₃, Cl, CN or part of a norbornene structure linked to R², the best results were not found with methyl, chlorine or cyano R³ groups.

More preferred co-monomers are acrylates and norbornenes having this structure. This includes acrylate compounds having the formula:
CX₂=CRC(O)OC(CF₃)(CH₃)₂, wherein X is H or F, and R is X, CF₃ or CH₃. For example, one preferred acrylate compound that has been found to be particularly useful for forming photoresists useful for 157 nm lithography is the compound 2-trifluoromethyl acrylic acid 2,2,2-trifluoro-1,1-dimethyl ethyl ester, which has the following structure:

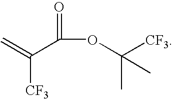

Other preferred co-monomers are norbornene compounds having the formula: 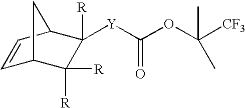
wherein R is F, H or fluoroalkyl, and wherein Y is nil, O, or a spacer group which comprises (CH₂)ₙ or (CF₂)ₙ wherein n is from 1 to about 5. For example, a norbornene co-monomer useful herein is the compound 3-trifluoromethyl-bicyclo[2.2.1]hept-5-ene-2-carboxylic acid-2,2,2-trifluoro-1,1-dimethyl-ethyl ester, which has the following structure:

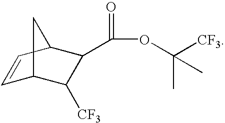

Another useful norbornene co-monomer is the compound bicyclo[2.2.1]hept-5-ene-2-carboxylic acid 2,2,2-trifluoro-1,1-dimethyl-ethyl ester, which has the following structure:

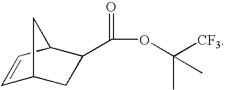

These three specific co-monomers have been found to be particularly desirable in the production of 157 nm photoresists. The monomer compounds of the invention preferably comprise from about 5% to about 50% by weight of the overall polymer for the photoresist compositions of the invention, more preferably from about 15% to about 40% by weight of the polymer, with the balance comprising other suitable co-monomers. The amount will depend on the solubility characteristics of the other monomers. For example, if one of the monomers is a fluorinated norbornene that has good solubility in a developer solution, then the amount of the monomer having the acid labile group will be lower. However, if one of the monomers, for example, has no solubilizing functional groups, such as a fluorinated ethylene, a higher percentage of the polymer will comprise monomers having the acid labile group.

In the preferred embodiment of the invention, the polymers have a molecular weight of from about 5000 to about 20000 amu, more preferably from about 5000 to about 10000 amu. The desired molecular weights for the polymers of the invention are sufficiently high that they are neither volatile nor a liquid, but are sufficiently low to ensure that the polymer is soluble in a suitable solvent for the photoresist formulation. Additionally, the polymer must be in the right molecular weight range so that, in the typical processing steps (i.e. photolysis and base wash), it will dissolve in the developer solution.

The photoresist compositions of the invention include at least one polymer of the invention in combination with at least one photo-acid generator that generates sufficient acid to remove the acid labile group of the polymer upon exposure to actinic radiation at a wavelength of about 157 nm, and a solvent that is capable of dissolving the polymer and the photo-acid generator. The term “photo-acid generator” is recognized in the art and is intended to include those compounds which generate acid in response to radiant energy. Preferred photoacid generators for use in the present invention are those that are reactive to deep UV radiation, e.g., to radiant energy having a wavelength equal to or less than 248 nm, and are preferably highly reactive to radiation at 157 nm. The combination of the photo-acid generator and polymer should be soluble in an organic solvent. Preferably, the solution of the photo-acid generator and polymer in the organic solvent are suitable for spin coating. The photo-acid generator can include a plurality of photo-acid generators.

The polymer is preferably present in the photoresist composition in an amount sufficient to form a uniform film of the composition components when it is coated on a substrate and dried. The photo-acid generator is present in an amount sufficient to generate sufficient acid to remove said acid labile group upon exposure to actinic radiation. More specifically, the polymer is preferably present in the overail photoresist composition in an amount of from about 50% to about 99% based on the weight of the solid, i.e. non-solvent parts of the composition. A more preferred range of polymer would be from about 80% to about 99% and most preferably from about 82% to about 95% by weight of the solid composition parts. The photo-acid generator is preferably present in an amount ranging from about 1% to about 50% based on the weight of the solid, i.e., non-solvent parts of the composition. A more preferred range of the photo-acid generator would be from about 5% to about 20% by weight of the solid composition parts.

Useful photo-acid generators capable of generating an acid upon exposure to sufficient activating energy at a wavelength of about 157 nm include onium compounds such as sulfonium, diazonium and iodonium salts and combinations thereof. Sulfonium salts are described in U.S. Pat. No. 4,537,854. Diazonium salts are described in Light Sensitive Systems, Kosar, J.; John Wiley & Sons, New York, 1965. Iodonium salts are described in U.S. Pat. No. 4,603,101. Particularly preferred onium salts are triphenylsulfonium nonaflate and 5-(trifluoromethyl)-dibenzothiophenium trifluoromethanesulfonate. Also suitable are ammonium salts, 2,6-nitrobenzylesters, 1,2,3-tri(methanesulfonyloxy)benzene, sulfosuccinimides and photosensitive organic halogen compounds as disclosed in Japanese Examined Patent Publication No. 23574/1979 and U.S. Pat. No. 6,468,712.

Examples of diphenyliodonium salts include diphenyliodonium triflate and diphenyliodonium tosylate. Examples of suitable bis(4-tert-butylphenyl)iodonium salts include bis(4-tert-butylphenyl)iodonium triflate, bis(4-tert-butylphenyl)iodonium camphorsulfate, bis(4-tert-butylphenyl)iodonium perfluorbutylate and bis(4-tert-butylphenyl)iodonium tosylate. Suitable examples of triphenylsulfonium salts include triphenylsulfonium hexafluorophosphite, triphenylsulfonium triflate and triphenylsulfonium perfluorobutylate.

In preparing the composition, the polymer and photo-acid generator are mixed with a sufficient amount of a solvent composition to form a uniform solution.

The solvent is not particularly limited, as long as it is a solvent capable of presenting adequate solubility to the polymer, photo-acid-generator and is capable of providing good coating properties. For example, it may be a cellosolve type solvent such as methyl cellosolve, ethyl cellosolve, methyl cellosolve acetate or ethyl cellosolve acetate. Ethylene glycol based solvents such as ethylene glycol monomethyl ether, ethylene glycol monoethyl ether acetate, diethylene glycol monomethyl ether, diethylene glycol dibutyl ether, diethylene glycol and diethylene glycol dimethyl ether (diglyme) are suitable as organic solvents for the photoresist compositions of the invention. Propylene glycol based solvents such as propylene glycol monoethyl ether, propylene glycol monobutyl ether, propylene glycol monomethyl ether acetate, dipropylene glycol dimethyl ether, propylene glycol monoethyl ether acetate or other propylene glycol alkyl ether acetate can be used. Suitable ester type solvents include butyl acetate, amyl acetate, ethyl butyrate, butyl butyrate, diethyl oxalate, ethyl pyruvate, ethyl-2-hydroxybutyrate, 2-methyl-acetoacetate, methyl lactate or ethyl lactate. Alternatively, alcohols are utilized and include heptanol, hexanol, nonanol, diacetone alcohol or furfuryl alcohol. Examples of suitable ketone solvents include cyclohexanone, cyclopentanone or methylamyl ketone. Ethers useful as solvating agents include methyl phenyl ether or diethylene glycol dimethyl ether. Polar solvents, such as dimethylformamide or N-methylpyrrolidone can also be used. The solvents can be used alone or as combinations of two or more solvents. Typically the solvent is used in an amount of from 1 to 100 times by weight, e.g., 20 to 30 times by weight, relative to the total amount of the solid content of the photoresist composition. The most preferred solvents are butyl acetate, ethylene glycol monoethyl ether acetate, diglyme, cyclopentanone and propylene glycol monomethyl ether acetate.

Suitable substrates onto which the photoresist composition of the invention are applied non-exclusively include silicon, aluminum, lithium niobate, polymeric resins, silicon dioxide, doped silicon dioxide, gallium arsenide, Group III/V compounds, silicon nitride, tantalum, copper, polysilicon, ceramics and aluminum/copper mixtures. Semiconductor substrates are most preferred. Lines may optionally be on the substrate surface. The lines, when present, are typically formed by well known lithographic techniques and may be composed of a metal, an oxide, a nitride or an oxynitride. Suitable materials for the lines include silica, silicon nitride, titanium nitride, tantalum nitride, aluminum, aluminum alloys, copper, copper alloys, tantalum, tungsten and silicon oxynitride. These lines form the conductors or insulators of an integrated circuit. Such are typically closely separated from one another at distances preferably of from about 20 micrometers or less, more preferably from about 1 micrometer or less, and most preferably of from about 0.05 to about 1 micrometer.

The composition may additionally contain additives such as colorants, dyes, antistriation agents, leveling agents, crosslinkers, plasticizers, adhesion promoters, speed enhancers, solvents, acid generators, dissolution inhibitors and non-ionic surfactants. Examples of dye additives that may be used together with the photoresist compositions of the present invention include Methyl Violet 2B (C.I. No. 42535), Crystal Violet (C.I. 42555), Malachite Green (C.I. No. 42000), Victoria Blue B (C.I. No. 44045) and Neutral Red (C.I. No. 50040) in an amount of from about 1.0 to about 10.0 percent, based on the combined weight of the solid parts of the composition. The dye additives help provide increased resolution by inhibiting back scattering of light off the substrate. Anti-striation agents may be used up to about five percent by weight, based on the combined weight of solids. Adhesion promoters which may be used include, for example, beta-(3,4-epoxy-cyclohexyl)ethyltrimethoxysilane; p-methyl-disilane-methyl methacrylate; vinyltrichlorosilane; and gamma-amino-propyl triethoxysilane up to about 4.0 percent by weight based on the combined weight of solids. Speed enhancers that may be used include, for example, picric acid, nicotinic acid or nitrocinnamic acid at up to about 20 percent, based on the combined weight of solids. These enhancers tend to increase the solubility of the photoresist coating in both the exposed and unexposed areas, and thus they are used in applications when speed of development is the overriding consideration even though some degree of contrast may be sacrificed; i.e., while the exposed areas of the photoresist coating will be dissolved more quickly by the developer, the speed enhancers will also cause a larger loss of photoresist coating from the unexposed areas. Non-ionic surfactants that may be used include, for example, nonylphenoxy poly(ethyleneoxy)ethanol; octylphenoxy(ethyleneoxy)ethanol; and dinonyl phenoxy poly(ethyleneoxy)ethanol at up to about 10 percent based on the combined weight of solids.

In the production of the microelectronic device of the present invention, one coats and dries the foregoing photoresist composition on a suitable substrate. The prepared resist solution can be applied to a substrate by any conventional method used in the photoresist art, including dipping, spraying, whirling and spin coating. When spin coating, for example, the resist solution can be adjusted as to the percentage of solids content in order to provide coating of the desired thickness given the type of spinning equipment utilized and the amount of time allowed for the spinning process. In a preferred embodiment of the invention, the photoresist layer is formed by centrally applying a liquid photoresist composition to the upper surface on a rotating wheel at speeds ranging from about 500 to about 6000 rpm, preferably from about 1500 to about 4000 rpm, for about 5 to about 60 seconds, preferably from about 10 to about 30 seconds, in order to spread the composition evenly across the upper surface. The thickness of the photoresist layer may vary depending on the amount of liquid photoresist composition that is applied, but typically the thickness may range from about 500 Angstroms (Å) to about 50,000 Å, and preferably from about 2000 Å to about 12000 Å. The amount of photoresist composition which is applied may vary from about 1 ml to about 10 ml, and preferably from about 2 ml to about 8 ml depending on the size of the substrate.

After the resist composition solution is coated onto the substrate, the substrate is temperature treated at approximately 20° C. to 200° C. This temperature treatment is done in order to reduce and control the concentration of residual solvents in the photoresist while not causing substantial thermal degradation of the photo-acid generator. In general one desires to minimize the concentration of solvents and thus this temperature treatment is conducted until substantially all of the solvents have evaporated and a thin coating of photoresist composition, on the order of a micron in thickness, remains on the substrate. In a preferred embodiment the temperature is conducted at from about 50° C. to about 150° C. A more preferred range is from about 70° C. to about 90° C. This treatment is conducted until the rate of change of solvent removal becomes relatively insignificant. The temperature and time selection depends on the resist properties desired by the user as well as equipment used and commercially desired coating times. Commercially acceptable treatment times for hot plate treatment are those up to about 3 minutes, more preferably up to about 1 minute. In one example, a 30 second treatment at 90° C. is useful. Treatment times increase to about 20 to about 40 minutes when conducted in a convection oven at these temperatures.

After deposition onto the substrate, the photoresist layer is imagewise exposed, such as via a fluorine laser or through a polysilicon etch mask to actinic radiation. This exposure renders the photoresist layer more soluble after exposure than prior to exposure. When such a resist is exposed to light, activated acid induces a catalytic chain reaction to a photoresist film organic polymer, generating a significant amount of protons. In the resist, protons bring a large change into the solubility of the resin. When the photoresist film is irradiated by a high energy beam, e.g. 157 nm, acid (H⁺) is generated, reacting with the polymer. Acid is again generated and reacts with unreacted polymer. The polymer is then dissolved in a developing solution. In contrast, the polymer at the non-exposed region maintains its structure, which is insoluble to the developing solution. With such a mechanism, a good profile pattern can be made on a wafer substrate. The amount of actinic radiation used is an amount sufficient to render the exposed portions of the photoresist layer imagewise soluble in a suitable developer. Preferably, UV radiation is used in an amount sufficient to render the exposed portions of the photoresist layer imagewise soluble in a suitable developer. UV exposure doses are preferably around about 40 mJ/cm². Preferably the process further comprises the step of heating the imagewise exposing the photoresist composition prior to developing, such as by baking, for a sufficient time and temperature to increase the rate at which the acid decomposes the polymer in the imagewise exposed areas of the photoresist composition. This drives the acid reaction for better image formation. Such a heat treatment may be conducted at temperatures of from about 50° C. to about 150° C., preferably from about 120° C. to about 150 C for from about 30 seconds to about 2 minutes.

The development step may be conducted by immersion in a suitable developing solution, preferably an aqueous alkaline solution. The solution is preferably agitated, for example, by nitrogen burst agitation. The substrates are allowed to remain in the developer until all, or substantially all, of the resist coating has dissolved from the irradiated areas. Typical examples of the aqueous alkaline solutions suitable as the developer include sodium hydroxide, tetramethylammonium hydroxide, or aqueous solutions of hydroxides of metals belonging to the Groups I and II of the periodic table such as potassium hydroxide. Aqueous solution of organic bases free from metal ions such as tetraalkylammonium hydroxide, for example, tetramethylammonium hydroxide (TMAH), tetraethylammonium hydroxide (TEAH) and tetrabutylammonium hydroxide (TBAH). More preferably, tetramethylammonium hydroxide (TMAH) are preferred. Furthermore, if desired, the aqueous basic solution used as the developer may additionally contain any additives such as a surface active agent in order to improve the resulting development effect. After removal of the coated wafers from the developing solution, an optional, although not required, post-development heat treatment or bake may be employed to increase the adhesion of the coating as well as resistance to etching solutions and other substances. The post-development heat treatment can comprise the oven baking of the coating and substrate below the coating's softening point. The result is an patterned image that may be subsequently transformed into a useful device, such as a microelectronic device suitable for forming semiconductors.

The procedures for making the monomers and polymers of the invention, as well as the preferred method for utilizing the polymers in a photoresist composition for use in microlithography, are described in the Examples hereinbelow.

### EXAMPLES

A general procedure for the preparation of polymers of the monomers of this invention is as follows:

A catalyst solution is prepared by mixing, in an inert atmosphere, allylpalladium chloride dimer and silver hexafluorantimonate in a molar ratio of about 1:2 to 1:3 (typically 1:2.5). To this mixture is added deoxygenated dichloroethane and the mixture is stirred for about 30 minutes. The result is a slurry of dissolved allyl Pd(SbF₆)₂ dimer and insoluble AgCl. The solution is then filtered through a 0.45 micron PTFE filter to remove the AgCl to give a clear catalyst solution.

The monomer is dissolved in 1,2-dichloroethane or other suitable solvent. The solution is stirred and purged with nitrogen to deoxygenate the system for 30 minutes prior to adding the catalyst. The catalyst is then added and a nitrogen purge is continued for an additional 15 minutes prior to placing it under a nitrogen blanket. The reaction mixture is stirred at room temperature for a total of about 2-24 h, during which time an increase in viscosity may be observed. The amounts of catalyst and monomer, relative to solvent, typically result in a solution that is 0.5 to 5 wt % catalyst and 5-30 wt % percent monomer (typically 20 wt %).

After the desired reaction period, the nitrogen blanket is removed and air is bubbled through the solution for 1 hour. Ethanol is added to the reaction flask to dilute the polymer. The solution is filtered through a 0.2 micron PTFE filter, and water is then added to the solution to precipitate the polymer. The polymer is finally filtered and dried.

Preparation of the Preferred Co-Monomers:

The preferred co-monomers of the invention can be made in a number of ways. For example, an acid RCOOH can be reacted with (CH₃)₂CF₃COH or with (CH₃)CF₃C═CH₂ in a process advantageously catalyzed by a strong mineral acid. Alternatively, an acid halide, i.e., RCOCl can be reacted with a metal salt of (CH₃)₂CF₃COH or the acid halide can reacted with the alcohol in the presence of a base. When an alcohol needs to be converted to a material with the (CH₃)₂CF₃CO— group, a carbonate can be prepared. That is, ROH is converted into ROC(O)OC(CF₃)(CH₃)₂. This can be accomplished by reacting either ROH or (CH₃)₂CF₃COH with phosgene to give an alkyl chloroformate, followed by reacting the chloroformate with the other alcohol. Alternatively, the alcohol in some cases can be converted to the ether, ROC(CF₃)(CH₃)₂.

### Example 1

### Preparation of 5-chloro-6-trifluoromethylnorborn-2-ene

Freshly distilled cyclopentadiene (16.5 g) and 52.0 g of trans-CF₃CH=CHCl were transferred to a cold 600-mL autoclave. The contents were heated to 174 C for 18 h. The maximum pressure was 255 psig, decreasing to 140 psig at the end of the heating period. Distillation gave 6.8 g volatile materials and 25.0 g of the desired product as a 21:75 mixture of isomers, bp 78 C at 50 mm Hg. ¹⁹F NMR for major isomer, −66.6 (doublet) and for the minor isomer, −68.4 (doublet) ppm.

### Example 2

### Preparation of 3-trifluoromethyl-2-fluorobicyclo[2.2.1]hept-5-ene

Freshly distilled cyclopentadiene (19.2 g) and 35 g of trans-CF₃CH=CHF were transferred to a cold 600-mL autoclave. The contents were heated to 170 C for 17 h. The maximum pressure was 320 psig, decreasing to 215 psig at the end of the heating period. Distillation provided the desired product, bp 55-56 C at 50 mm Hg. Analysis by GC-MS indicated isomers with a molecular ion peak at m/e=180 and similar fragmentation patterns. ¹⁹F NMR: isomer A, −66.2 (d, 3 F) and −174.5 (dd, 1 F); isomer B, −68.3 (d, 3 F) and −183.7 (dd, 1F) ppm. By ¹H NMR, isomer A was assigned to the isomer with an endo CF₃ group, while isomer B to the isomer with an exo CF₃ group.

### Example 3

### Preparation of 5,5-difluoro-6-trifluoromethylnorbom-2-ene

In a manner similar to the above, cyclopentadiene and 2-H-pentafluoropropene were heated to 175 C for 16 hours. Distillation gave a 63:37 ratio of isomers boiling at 60-61 C at 50 mm Hg. ¹⁹F NMR for the major isomer (CF₃ group endo): −65.7 (3 F), −89.5 (dd, 1 F), and −110.2 (d, 1 F) ppm. ¹⁹F NMR for the minor isomer (CF₃ group exo): −67.0 (3 F), −97.0 (dd, 1 F), and −109.6 (d, 1 F) ppm.

### Example 4

### Polymerization of 5-fluoro-6-trifluoromethylbicyclo[2.2.1]hept-2-ene

To a 50-mL 3-neck round bottom flask equipped with a Teflon® coated stir bar, septum inlet, and a reflux condenser was added 1,2 dichloroethane (3.9 mL) and 3-trifluoromethyl-2-fluorobicyclo[2.2.1]hept-5-ene (2 g, 11.1 mmol). To this stirred solution at ambient temperature was added a catalyst solution prepared by reacting η³-allyl palladium chloride dimer (40.64 mg, 0.111 mmol) with silver hexafluoroantimonate (79.0 mg, 0.230 mmol) in 1,2 dichloroethane (3 mL) for 30 minutes followed by filtration through a 0.45 micron filter. The reaction was allowed to run for 18 hours at which time the solvent was flashed off and the remaining polymer was dried at 80° C. under vacuum. The yield of the homopolymer was 1.0 g (50%). The molecular weight of the homopolymer was determined to be 4172 g/mole (Mw) with a polydispersity of 2.8 (GPC in THF, polystyrene standards). Thermogravimetric analysis (TGA) under nitrogen (heating rate of 10° C./minute) showed the polymer to be thermally stable to 200° C.

### Example 5

### Copolymerization of 5-fluoro-6-trifluoromethylbicyclo[2.2.1]hept-2-ene and 2-bicyclo[2.2.1]hept-5-en-2ylmethyl-1,1,1,3,3,3-hexafluoropropan-2-ol

To a 50-mL 3-neck round bottom flask equipped with a Teflon® coated stir bar, septum inlet, and a reflux condenser was added 1,2 dichloroethane (3.9 mL), 3-trifluoromethyl-2-fluorobicyclo[2.2.1]hept-5-ene (1 g, 5.55 mmol), and 2-bicyclo[2.2.1]hept-5-en-2ylmethyl-1,1,1,3,3,3-hexafluoropropan-2-ol (1.52 g, 5.55 mmol). To this stirred solution at ambient temperature was added a catalyst solution prepared by reacting η³-allyl palladium chloride dimer (40.64 mg, 0.111 mmol) with silver hexafluoroantimonate (76.39 mg, 0.222 mmol) in 1,2 dichloroethane (3 mL) for 30 minutes and then filtering through a 0.45 micron filter. The reaction was allowed to run for 18 hours at which time the solvent was flashed off and the remaining polymer was dried at 80° C. under vacuum. The yield of the copolymer was 1.5 g (60%). The molecular weight of the copolymer was determined to be 4100 g/mole (Mw) with a polydispersity of 1.8 (GPC in THF, polystyrene standards). Thermogravimetric analysis (TGA) under nitrogen (heating rate of 10° C./minute) showed the polymer to be thermally stable to 200° C.

Using methods similar to those in Examples 4 and 5, additional copolymers were prepared and are shown in the following Table:

TABLE 1

| COPOLYMER DATA FOR TETRAFLUORO AND PENTAFLUORO METHYL | | | | | |
|---|---|---|---|---|---|
| NORBORNENES | | | | | |
| Monomer A | Monomer B | Conditions | Tg or Tm | Yield | MW |
| 5-fluoro-6-trifluoromethyl- | none | RT; 1% Pd(SbF₆)₂ | | 50% | 4172 |
| bicyclo{2.2.2]hept-2-ene | | | | | |
| 5-fluoro-6-trifluoromethyl- | none | 70° C.; 1% Pd(SbF₆)₂ | | 75% | |
| bicyclo{2.2.2]hept-2-ene | | | | | |
| 5-fluoro-6-trifluoromethyl- | 2-trifluoromethyl acrylic | 1:1 mole ratio; 90° C.; | Tm = 160° C. | 20% | |
| bicyclo{2.2.2]hept-2-ene | acid t-butyl ester | 5% AIBN | | | |
| 5-fluoro-6-trifluoromethyl- | 2-bicyclo[2.2.1]hept-5-en- | 1:1 mole ratio; RT; | Tm = 200° C. | 60% | |
| bicyclo{2.2.2]hept-2-ene | 2-ylmethyl-1,1,1,3,3,3-hexa- | 1% Pd(SbF₆)₂ | | | |
| | fluoropropan-2-ol | | | | |
| 5-fluoro-6-trifluoromethyl- | 2-bicyclo[2.2.1]hept-5-en- | 1:1 mole ratio; 70° C.; | | 100% | |
| bicyclo{2.2.2]hept-2-ene | 2-ylmethyl-1,1,1,3,3,3-hexa- | 1% Pd(SbF₆)₂ | | | |
| | fluoropropan-2-ol | | | | |
| 5-fluoro-6-trifluoromethyl- | 3-trifluoromethyl-bicyclo[2.2.2] | 1:1 mole ratio; RT; | | 36% | 4057 |
| bicyclo{2.2.2]hept-2-ene | hept-5-ene-carboxylic acid | 1% Pd(SbF₆)₂ | | | |
| | 2,2,2-trifluoro-1,1-dimethyl | | | | |
| | ethyl ester | | | | |
| 5-fluoro-6-trifluoromethyl- | 3-trifluoromethyl-bicyclo[2.2.2] | 1:1 mole ratio; 70° C.; | | 75% | |
| bicyclo{2.2.2]hept-2-ene | hept-5-ene-carboxylic acid | 1% Pd(SbF₆)₂ | | | |
| | 2,2,2-trifluoro-1,1-dimethyl | | | | |
| | ethyl ester | | | | |
| 5-fluoro-6-trifluoromethyl- | bicyclo[2.2.1]hept-5-ene-2- | 1:1 mole ratio; RT; | Tg = 150° C. | 70% | 3792 |
| bicyclo{2.2.2]hept-2-ene | carboxylic acid 2,2,2-trifluoro- | 1% Pd(SbF₆)₂ | | | |
| | 1,1-dimethyl ethyl ester | | | | |
| 5-fluoro-6-trifluoromethyl- | bicyclo[2.2.1]hept-5-ene-2- | 1:1 mole ratio; 70° C.; | Tg = 135° C. | 70% | |
| bicyclo{2.2.2]hept-2-ene | carboxylic acid 2,2,2-trifluoro- | 1% Pd(SbF₆)₂ | | | |
| | 1,1-dimethyl ethyl ester | | | | |
| 5,5-difluoro-6-trifluoromethyl- | none | 70° C.; 1% Pd(SbF₆)₂ | Tg = 152° C. | 15% | 8871 |
| bicyclo[2.2.1]hept-2-ene | | | | | |
| 5,5-difluoro-6-trifluoromethyl- | 2-bicyclo[2.2.1]hept-5-en- | 1:1 mole ratio; RT; | | 59% | 8361 |
| bicyclo[2.2.1]hept-2-ene | 2-ylmethyl-1,1,1,3,3,3-hexa- | 1% Pd(SbF₆)₂ | | | |
| | fluoropropan-2-ol | | | | |
| 5,5-difluoro-6-trifluoromethyl- | 2-bicyclo[2.2.1]hept-5-en- | 1:1 mole ratio; 70° C.; | | 71% | |
| bicyclo[2.2.1]hept-2-ene | 2-ylmethyl-1,1,1,3,3,3-hexa- | 1% Pd(SbF₆)₂ | | | |
| | fluoropropan-2-ol | | | | |
| 5,5-difluoro-6-trifluoromethyl- | 3-trifluoromethyl-bicyclo[2.2.2] | 1:1 mole ratio; RT; | | 30% | 3226 |
| bicyclo[2.2.1]hept-2-ene | hept-5-ene-carboxylic acid | 1% Pd(SbF₆)₂ | | | |
| | 2,2,2-trifluoro-1,1-dimethyl | | | | |
| | ethyl ester | | | | |
| 5,5-difluoro-6-trifluoromethyl- | 3-trifluoromethyl-bicyclo[2.2.2] | 1:1 mole ratio; 70° C.; | | 42% | |
| bicyclo[2.2.1]hept-2-ene | hept-5-ene-carboxylic acid | 1% Pd(SbF₆)₂ | | | |
| | 2,2,2-trifluoro-1,1-dimethyl | | | | |
| | ethyl ester | | | | |
| 5,5-difluoro-6-trifluoromethyl- | 2-trifluoromethyl acrylic | 1:1 mole ratio; 85° C.; | | | |
| bicyclo[2.2.1]hept-2-ene | acid t-butyl ester | 5% AIBN | | | |
| 5,5-difluoro-6-trifluoromethyl- | bicyclo[2.2.1]hept-5-ene-2- | 1:1 mole ratio; RT; | Tg = 145° C. | 70% | 3979 |
| bicyclo[2.2.1]hept-2-ene | carboxylic acid 2,2,2-trifluoro- | 1% Pd(SbF₆)₂ | | | |
| | 1,1-dimethyl ethyl ester | | | | |
| 5,5-difluoro-6-fluoro-6-trifluoro- | none | 70° C.; 1% Pd(SbF₆)₂ | | <10% | |
| methylbicyclo[2.2.1]hept-2-ene | | | | | |

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A compound having the structure: 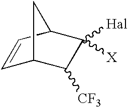
wherein Hal=F, Cl or Br and X=H or F.

2. The compound of claim 1 wherein Hal=F and X=H.

3. The compound of claim 1 wherein Hal=F and X=F.

4. A polymer which comprises a homopolymer or copolymer which is derived from at least one member which member comprises a compound having the structure: 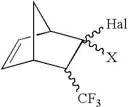
wherein Hal=F, Cl or Br and X=H or F.

5. The polymer of claim 4 wherein Hal=F and X=H.

6. The polymer of claim 4 wherein Hal=F and X=F.

7. The polymer of claim 4 which has a molecular weight of from about 5000 to about 20000 amu.

8. The polymer of claim 4 which is substantially transparent to ultraviolet radiation at a wavelength of 157 nm.

9. The polymer of claim 4 which comprises a copolymer which is derived from said at least one member and further derived from at least one co-member, which co-member comprises at least one acid labile group.

10. The polymer of claim 9 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃, CH₃, Cl, CN or part of a norbornene structure linked to R²; Y is a nil or a spacer group which comprises an alkylene or fluorinated alkylene moiety of 1-5 carbons.

11. The polymer of claim 9 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; Y is a nil or a spacer group which comprises an alkylene or fluorinated alkylene moiety of 1-5 carbons.

12. The polymer of claim 9 which co-member comprises an acrylate having the formula:
CX₂=CRC(O)OC(CF₃)(CH₃)₂,
wherein X is H or F, and R is X, CF₃ or CH₃.

13. The polymer of claim 9 which co-member comprises a norbornene having the structure: 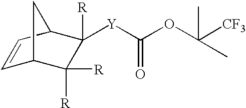
wherein R is F, H or fluoroalkyl, and wherein Y is nil, 0, or a spacer group which comprises (CH₂)ₙ or (CF₂)ₙ wherein n is from 1 to about 5.

14. The polymer of claim 4 which comprises a copolymer which is derived from said at least one member and further derived from at least one co-member, which co-member comprises at least one fluorinated acrylate, fluorinated norbornene or fluorinated norbornenol.

15. A photoresist composition comprising:
(a) at least one polymer which comprises a copolymer which is derived from at least one member which member comprises a compound having the structure: 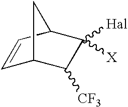
where Hal=F, Cl or Br and X=H or F;
(b) at least one photoacid generator in an amount sufficient to generate sufficient acid to remove said acid labile group upon exposure to actinic radiation; and
(c) a solvent capable of dissolving the polymer and the photoacid generator;
wherein said polymer is present in the photoresist composition in an amount sufficient to form a uniform film of the composition components when it is coated on a substrate and dried.

16. The photoresist composition of claim 15 wherein the polymer is substantially transparent to ultraviolet radiation at a wavelength of about 157 nm, and wherein the photoacid generator generates sufficient acid to remove said acid labile group upon exposure to actinic radiation at a wavelength of about 157 nm.

17. The photoresist composition of claim 15 wherein Hal=F and X=H.

18. The photoresist composition of claim 15 wherein Hal=F and X=F.

19. The photoresist composition of claim 15 which polymer has a molecular weight of from about 5000 to about 20000 amu.

20. The photoresist composition of claim 15 which is substantially transparent to ultraviolet radiation at a wavelength of 157 nm.

21. The photoresist composition of claim 15 which comprises a copolymer which is derived from said at least one member and further derived from at least one co-member, which co-member comprises at least one acid labile group.

22. The photoresist composition of claim 21 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃, CH₃, Cl, CN or part of a norbornene structure linked to R²; Y is a nil or a spacer group which comprises an alkylene or fluorinated alkylene moiety of 1-5 carbons.

23. The photoresist composition of claim 21 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; Y is a nil or a spacer group which comprises an alkylene or fluorinated alkylene moiety of 1-5 carbons.

24. The photoresist composition of claim 21 which co-member comprises an acrylate having the formula:
CX₂=CRC(O)OC(CF₃)(CH₃)₂,
wherein X is H or F, and R is X, CF₃ or CH₃.

25. The photoresist composition of claim 21 which co-member comprises a norbornene having the structure: 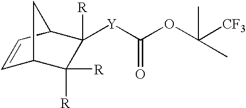
wherein R is F, H or fluoroalkyl, and wherein Y is nil, O, or a spacer group which comprises (CH₂)ₙ or (CF₂)ₙ wherein n is from 1 to about 5.

26. The photoresist composition of claim 15 which comprises a copolymer which is derived from said at least one member and further derived from at least one co-member, which co-member comprises at least one fluorinated acrylate, fluorinated norbornene or fluorinated norbornenol.

27. The photoresist composition of claim 15 which photoacid generator comprises an onium compound.

28. The photoresist composition of claim 15 wherein the photosensitive compound comprises a sulfonium, iodonium or diazonium compound or combinations thereof.

29. The photoresist composition of claim 15 wherein said solvent is selected from the group consisting of butyl acetate, ethylene glycol monoethyl ether acetate, diglyme, cyclopentanone and propylene glycol monomethyl ether acetate.

30. The photoresist composition of claim 15 wherein said polymer is present in the photoresist composition in an amount of from about 50% to about 99% and the photoacid generator is present in an amount of from about 1% to about 50% based on the weight of the non-solvent parts of the photoresist composition.

31. A process for producing an etch resistant image which comprises:
(a) coating and drying a photoresist composition onto a substrate, which photoresist composition comprises:
(i) at least one polymer which comprises a copolymer which is derived from at least one member which member comprises a compound having the structure: 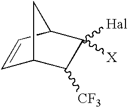
where Hal=F, Cl or Br and X═H or F; and
(ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the exposed non-image areas and leaving the unexposed image areas of the photoresist composition.

32. The process of claim 31 wherein the polymer is substantially transparent to ultraviolet radiation at a wavelength of about 157 nm, and wherein the photoacid generator generates sufficient acid to remove said acid labile group upon exposure to actinic radiation at a wavelength of about 157 nm.

33. The process of claim 31 wherein Hal=F and X=H.

34. The process of claim 31 wherein Hal=F and X=F.

35. The process of claim 31 which polymer has a molecular weight of from about 5000 to about 20000 amu.

36. The process of claim 31 wherein the photoresist composition is exposed to activating energy at a wavelength of about 157 nm.

37. The process of claim 31 which comprises a copolymer which is derived from said at least one member and further derived from at least one co-member, which co-member comprises at least one acid labile group.

38. The process of claim 37 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃, CH₃, Cl, CN or part of a norbornene structure linked to R²; Y is a nil or a spacer group which comprises an alkylene or fluorinated alkylene moiety of 1-5 carbons.

39. The process of claim 37 which co-member comprises a compound having the structure:
CR¹R²=CR³—Y—C(O)OC(CH₃)₂CF₃
where R¹ is H, F or part of a norbornene structure linked to R³; R² is H or F; R³ is H, F, CF₃ or part of a norbornene structure linked to R²; Y is a nil or a spacer group which comprises an alkylene or fluorinated alkylene moiety of 1-5 carbons.

40. The process of claim 37 which co-member comprises an acrylate having the formula:
CX₂=CRC(O)OC(CF₃)(CH₃)₂,
wherein X is H or F, and R is X, CF₃ or CH₃.

41. The process of claim 37 which co-member comprises a norbornene having the structure: 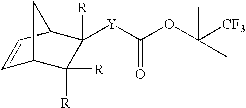
wherein R is F, H or fluoroalkyl, and wherein Y is nil, O, or a spacer group which comprises (CH₂)ₙ or (CF₂)ₙ wherein n is from 1 to about 5.

42. The process of claim 31 which comprises a copolymer which is derived from said at least one member and further derived from at least one co-member, which co-member comprises at least one fluorinated acrylate, fluorinated norbornene or fluorinated norbornenol.

43. The process of claim 31 which photoacid generator comprises an onium compound.

44. The process of claim 31 wherein the photosensitive compound comprises a sulfonium, iodonium or diazonium compound or combinations thereof.

45. The process of claim 31 wherein the substrate is selected from the group consisting of silicon, aluminum, lithium niobate, polymeric resins, silicon dioxide, doped silicon dioxide, gallium arsenide, Group III/V compounds, silicon nitride, tantalum, copper, polysilicon, ceramics and aluminum/copper mixtures.

46. The process of claim 31 wherein the exposing is conducted with a fluorine laser.

47. The process of claim 31 wherein the developing is conducted with an aqueous alkaline solution.

48. The process of claim 31 further comprising the step of heating the exposed photoresist composition prior to developing for a sufficient time and temperature to increase the rate at which the acid decomposes the polymer in the imagewise exposed areas of the photoresist composition.

49. A microelectronic device image produced by a process which comprises:
(a) coating and drying a photoresist composition onto a substrate, which photoresist composition comprises:
(i) at least one polymer which comprises a copolymer which is derived from at least one member which member comprises a compound having the structure: 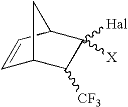
where Hal=F, Cl or Br and X=H or F; and
(ii) at least one photoacid generator in an amount sufficient to generate sufficient acid to remove said acid labile group upon exposure to actinic radiation;
(b) imagewise exposing the photoresist composition to sufficient activating energy to cause the photoacid generator to generate sufficient acid to decompose the polymer in the imagewise exposed areas of the photoresist composition; and
(c) developing the photoresist composition to thereby remove the exposed non-image areas and leaving the unexposed image areas of the photoresist composition.
